(19) United States
(12) Patent Application Publication
(10) Pub. No.: US 2006/0073818 A1
(43) Pub. Date: Apr. 6, 2006

(54) Mobile wireless communications device providing enhanced text navigation indicators and related methods

(75) Inventor: Sherryl Lee Lorraine Scott, Toronto (CA)

Correspondence Address: ALLEN, DYER, DOPPELT, MILBRATH & GILCHRIST P.A., 1401 CITRUS CENTER 255 SOUTH ORANGE AVENUE, P.O. BOX 3791, ORLANDO, FL, 32802-3791, US

(73) Assignee: Research In Motion Limited, Waterloo (CA)

(21) Appl. No.: 10/946,385

(22) Filed: Sep. 21, 2004

(51) Int. Cl. H04M 3/00

(52) U.S. Cl. 455/418

(57) ABSTRACT

A mobile wireless communications device may include a portable, handheld housing, and a display and keypad carried by the housing. In particular, the keypad may include a plurality of symbol keys each having indicia of at least one respective symbol thereon, and an alternate function key. A user input device and a controller may also be carried by the portable, handheld housing. The controller may be connected to the display and the keypad, and it may generate a menu of possible desired words based upon actuation of the symbol keys, and generate a word cursor in the menu for scrolling through the possible desired words based upon the user input device. The controller may also change the word cursor to a symbol cursor based upon actuation of the alternate function key for scrolling through symbols in the possible desired words based upon the user input device.

### FIELD OF THE INVENTION

The present invention relates to the field of communications devices, and, more particularly, to mobile wireless communications devices and related methods.

### BACKGROUND OF THE INVENTION

Cellular communications systems continue to grow in popularity and have become an integral part of both personal and business communications. Cellular phones allow users to place and receive voice calls most anywhere they travel. Moreover, as cellular telephone technology has increased, so too has the functionality of cellular devices. For example, many cellular devices now incorporate personal digital assistant (PDA) features such as calendars, address books, task lists, etc. Moreover, such multi-function devices may also allow users to wirelessly send and receive electronic mail (email) messages and access the Internet via a cellular network.

Because of the reduced display and keypad size on such mobile, handheld devices, users often find it somewhat more cumbersome to perform text entry on such devices as compared to a personal computer (PC), for example. Similarly, the visual queues that users receive while entering text in mobile, handheld devices for indicating text entry modes, functions, etc., are also typically more limited than would be the case with a PC.

Various approaches have been used for providing more helpful visual indications to users when performing text or data entry. By way of example, U.S. Pat. No. 6,259,432 to Yamada et al. discloses an information processing apparatus that can adjust the scrolling speed for data displayed in an application window on a display, and display a visual scrolling speed indicator. When the user manipulates a mouse to request scrolling of data in a window, the display form of the mouse cursor is changed. That is, in addition to the mouse cursor, one or more speed indicators (i.e., arrows) appears in the scrolling direction. The number of speed indicators which are displayed corresponds to the scrolling speed. The speed indicators are arranged from the center of the mouse cursor in the scrolling direction.

While such systems may be helpful for PC users, further visual indication features may be desirable in certain mobile, handheld device applications.

### SUMMARY OF THE INVENTION

In view of the foregoing background, it is therefore an object of the present invention to provide a mobile wireless communications device which provides enhanced visual cursor indications and related methods.

This and other objects, features, and advantages in accordance with the present invention are provided by a mobile wireless communications device which has enhanced text navigation indicators to a visual distinction between word and symbol scrolling modes. More particularly, the device may include a portable, handheld housing, and a display and keypad carried by the portable, handheld housing. The keypad may include a plurality of symbol keys each having indicia of at least one respective symbol thereon, and an alternate function key. A user input device and a controller may also be carried by the portable, handheld housing. The controller may be connected to the display and the keypad, and it may be for generating a menu of possible desired words based upon actuation of the symbol keys, and generating a word cursor in the menu for scrolling through the possible desired words based upon the user input device. The controller may also be for changing the word cursor to a symbol cursor based upon actuation of the alternate function key for scrolling through symbols in at least one of the possible desired words based upon the user input device.

As a result, a user is more readily able to determine that different modes for navigating the possible desired words in the menu are available. Further, the controller may also allow at least one possible desired word in the menu to be edited when symbol scrolling is active. Thus, the user has the ability to quickly select and/or modify possible desired words and therefore enter desired words more rapidly when typing in a predictive mode, for example.

The controller may change the word cursor to the symbol cursor based upon actuation of the alternate function key and the user input device. The controller may also generate a scrolling mode indicator in the menu for indicating whether word scrolling or symbol scrolling is active. Further, the controller may cause the scrolling mode indicator to change appearance based upon actuation of the alternate function key to indicate that symbol scrolling is active. By way of example, the scrolling mode indicator may include at least one arrow, and the controller may cause the at least one arrow to change direction upon actuation of the alternate function key.

In addition, the symbol cursor may be for scrolling through symbols in a last word selected by the word cursor, and the user input device may be a scroll wheel. The mobile wireless communications may also advantageously include a wireless transceiver carried by the portable, handheld housing for cooperating with the controller to communicate over a wireless network. By way of example, the wireless transceiver may be a cellular transceiver for communicating over a cellular telephone network, and/or a wireless local area network (WLAN) transceiver for communicating over a WLAN.

A set of the symbol keys on the keypad may have indicia of a plurality of respective symbols thereon to define multi-symbol keys. Further, the symbols on the keys may be letters, and the symbol keys may be arranged to define a QWERTY layout, for example.

A method aspect of the invention is for using a mobile wireless communications device, such as the one described briefly above. The method may include generating a menu of possible desired words based upon actuation of the symbol keys, generating a word cursor in the menu for scrolling through the possible desired words based upon the user input device, and changing the word cursor to a symbol cursor based upon actuation of the alternate function key for scrolling through symbols in at least one of the possible desired words based upon the user input device.

### BRIEF DESCRIPTION OF THE DRAWINGS

FIG. 1 is front elevational view of a mobile wireless communications device in accordance with the present invention.

FIG. 2 is schematic block diagram of the mobile wireless communications device of FIG. 1.

FIGS. 3 through 6 are screen prints of the display of the mobile wireless communications device of FIG. 1 illustrating changing of a word cursor to a symbol cursor in a menu of possible desired words.

FIG. 7 is a schematic block diagram of an alternate embodiment of the mobile wireless communications device of FIG. 1.

FIG. 8 is a flow diagram illustrating a mobile wireless communications method in accordance with the present invention.

FIG. 9 is a schematic block diagram of an exemplary mobile wireless communications device for use with the present invention.

### DETAILED DESCRIPTION OF THE PREFERRED EMBODIMENTS

The present invention will now be described more fully hereinafter with reference to the accompanying drawings, in which preferred embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like numbers refer to like elements throughout, and prime notation is used to indicate similar elements in alternate embodiments.

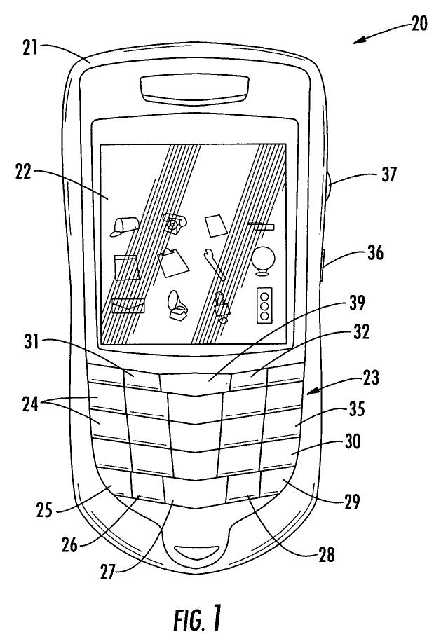

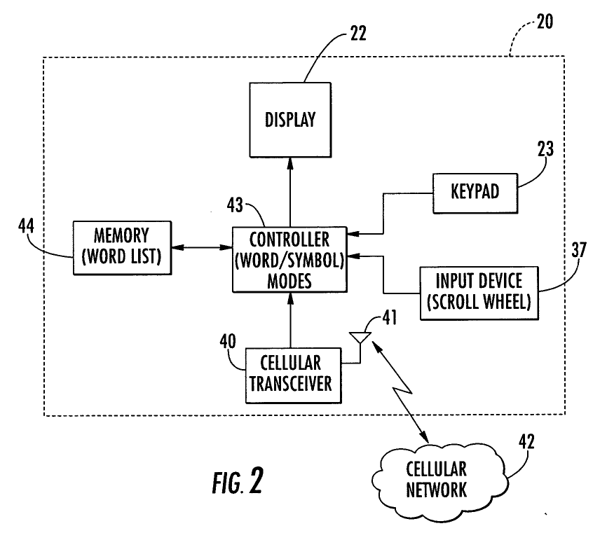

Referring initially to FIGS. 1 and 2, a mobile wireless communications device 20 in accordance with the invention is first described. In the illustrated embodiment, the device 20 is a mobile cellular communications device which includes a cellular transceiver 40 and associated antenna 41 for communicating over a cellular network 42. In particular, the cellular transceiver 40 may be used for cellular telephone calls as with traditional cellular telephones, and it also preferably cooperates with a controller 43 for sending other data, such as email/Internet data, over the cellular network 42 as well, as will be appreciated by those skilled in the art.

The device 20 illustratively includes a portable, handheld housing 21, and a display 22 and keypad 23 carried by the housing. A back button 36 and a scroll wheel 37 are also carried by the housing 21 and are connected to the controller 43 for allowing a user to navigate menus, text, etc., as will be appreciated by those skilled in the art. The scroll wheel 37 may also be referred to as a “thumb wheel” or a “track wheel” in some instances. The keypad 23 illustratively includes a plurality of multi-symbol keys 24 each having indicia of a plurality of respective symbols thereon, although multi-symbol keys need not be used in all embodiments. The keypad 23 also illustratively includes an alternate function key 25, a next key 26, a space key 27, a shift key 28, a return (or enter) key 29, and a backspace/delete key 30.

The next key 26 is also used to enter a “*” symbol upon first pressing or actuating the alternate function key 25. Similarly, the space key 27, shift key 28 and backspace key 30 are used to enter a “0” and “#”, respectively, upon first actuating the alternate function key 25. The keypad 23 further illustratively includes a send key 31, an end key 32, and a convenience (i.e., menu) key 39 for use in placing cellular telephone calls, as will be appreciated by those skilled in the art.

Moreover, the symbols on each key 24 are arranged in top and bottom rows. The symbols in the bottom rows are entered when a user presses a key 24 without first pressing the alternate function key 25, while the top row symbols are entered by first pressing the alternate function key. As seen in FIG. 1, the multi-symbol keys 24 are arranged in the first three rows on the keypad 23 below the off-hook and on-hook keys 31, 32. Furthermore, the letter symbols on each of the keys 24 are arranged to define a QWERTY layout. That is, the letters on the keypad 23 are presented in a three-row format, with the letters of each row being in the same order and relative position as in a standard QWERTY keyboard.

Each row of keys (including the fourth row of function keys 25-29) are arranged in five columns. The multi-symbol keys 24 in the second, third, and fourth columns of the first, second, and third rows have numeric indicia thereon (i.e., 1 through 9) accessible by first actuating the alternate function key 25. Coupled with the next, space, and shift keys 26, 27, 28, which respectively enter a “*”, “0”, and “#” upon first actuating the alternate function key 25, as noted above, this set of keys defines a standard telephone keypad layout, as would be found on a traditional touch-tone telephone, as will be appreciated by those skilled in the art.

The reason that more than one letter appears on most of the keys 24 is so that less than a full set of QWERTY keys, as found on a traditional computer/typewriter keyboard, can be used to access all of the English alphabet letters. This advantageously allows the footprint of the keypad 23 to remain relatively small which, in turn, allows the overall size of the mobile wireless communications device 20 to be decreased as well.

Yet, as also mentioned above, the tradeoff with placing multiple symbols on a single key is that typing (e.g., typing emails) becomes more difficult for users. To make typing easier, the controller 43 preferably allows symbols/text to be entered in two different modes, namely a multi-tap mode and a predictive mode. In the multi-tap mode, a user enters a desired symbol by pressing a given key a number of times corresponding to its position on the key. Thus, for example, for a user to enter a “W,” she would press the QW/! key twice. To enter an exclamation point, the user would press the alternate function key 25 before pressing the QW/! key.

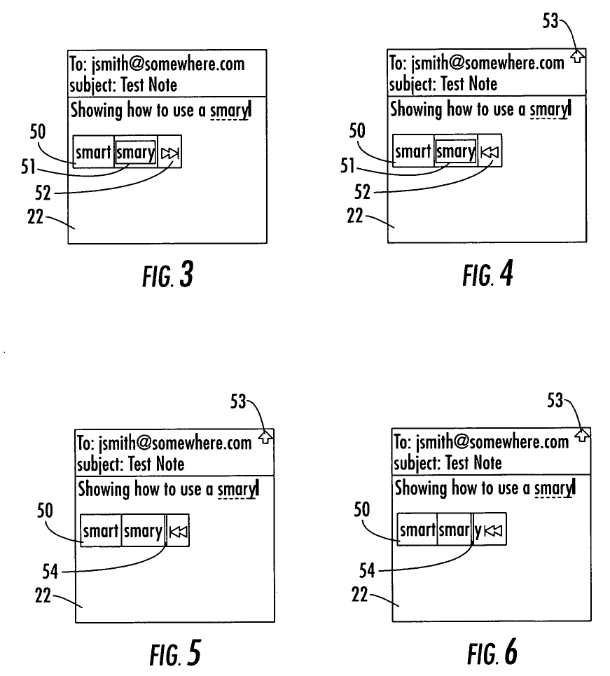

Referring more particularly to FIGS. 3 through 6, in a predictive mode, the controller 43 compares respective symbols corresponding to actuated multi-symbol keys 24 to a list (i.e., dictionary) of words and/or phrases, which is stored in a memory 44. The controller 43 generates a menu 50 of possible desired words based upon the combination of keys 24 that are pressed, as will be appreciated by those skilled in the art. The possible desired words may be generated according to various rules, such as a general frequency of use of the words, a frequency of use of the words by the user, alphabetically, etc., or a combination thereof. In the illustrated example, for the current word being typed by the user (indicated with dashed underlining), the controller 43 displays the text “smary”, which results in possible word choices of “smart” and “smary” in the menu 50. The controller 43 will cause the first word in the menu 50 (i.e., “smart”) to be initially highlighted with a word cursor 51, and the user may then use the scroll wheel 37 to scroll through other words in the list, as in FIG. 3.

The word cursor 51 can be moved back and forth through the menu 50 using the scroll wheel 37 to highlight a desired word for selection by the user. The user can select a given word by pressing the scroll wheel 37 inward, or by pressing the return key 29 or space key 27, for example. Once a desired word is selected, the controller 43 inserts the selected word in the active document (e.g., an email, notepad document, etc.), and the process begins again when the user starts entering symbols for a next word.

The controller 43 also preferably generates a scrolling mode or “next” indicator 52 in the menu 50 for indicating whether word scrolling or symbol scrolling is active. In the illustrated example, the scrolling mode indicator 53 is a “ [symbol] ” symbol, i.e., two right-facing arrowheads pointing at a vertical line. Of course, other scrolling mode indicators may be used as well. The symbol scrolling mode is selected by first actuating the alternate function key 25 when the menu 50 is displayed, and then scrolling (or rolling) the scroll wheel 37.

More particularly, when the alternate function key 25 is actuated by a user, the controller 43 displays an alternate function indicator 53 (e.g., an “A” symbol) in the upper right hand corner of the display 22. The controller 43 then dynamically changes the appearance of the scrolling mode indicator 52 to a “ [symbol] ” (i.e., two left-facing arrowheads pointing at a vertical line) upon actuation of the scroll wheel 37. This informs the user that the ability to move or scroll back through the individual symbols of the last word highlighted by the word cursor 51 is now active. Moreover, when the user rolls the scroll wheel 37, the controller 43 changes the word cursor 51 to a symbol cursor 54, as seen in FIGS. 5 and 6, to provide still further visual indication of the change in scrolling modes to the user.

In some embodiments, the controller 43 may also change the color of the symbol cursor 54 (and/or the word cursor 51) and the scrolling mode indicator 52 to be the same color, to provide still further visual indication of the change in scrolling nodes. Also, if a user wants to switch from the symbol cursor 54 back to the word cursor 51, this may be done by scrolling the symbol cursor outside of the current word, at which point it would change back to the word cursor. This may be also be done by first pressing the alternate function key 25 and then actuating the scroll wheel 37.”

As a result, a user is more readily able to determine that different modes for navigating the possible desired words in the menu 50 are available. Further, the controller 43 also preferably allows the selected word to be edited when symbol scrolling is active. Thus, users have the ability to quickly select and/or modify possible desired words and therefore enter desired words more rapidly when typing in the predictive mode, for example. Of course, it should be noted that in certain embodiments the controller 43 may allow the symbol cursor 54 to scroll back and forth between symbols of different words, and allow editing of multiple words, for example, if desired.

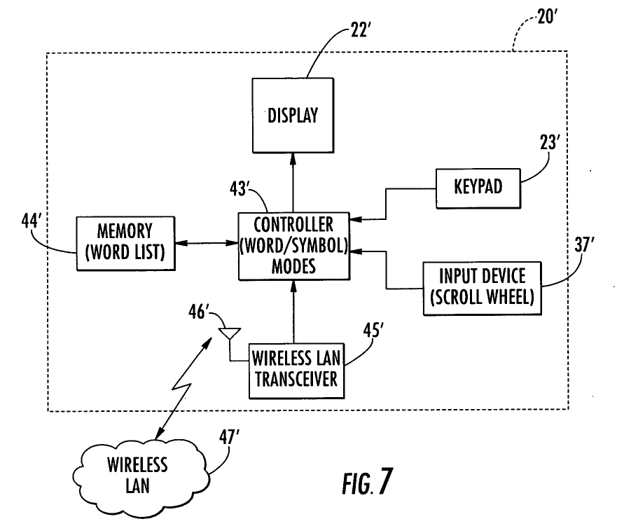

Turning additionally to FIG. 7, the mobile wireless communications device 20′ may optionally include a wireless transceiver 45′, such as a wireless local area network (LAN) (e.g., IEEE802.11/Bluetooth) transceiver, and associated antenna 46′ carried by the portable, handheld housing. The controller 43′ cooperates with the wireless transceiver 45′ to communicate information, such as voice, email, or Internet data, for example, over a wireless personal or local area network 47′, as will be appreciated by those skilled in the art. In other embodiments, both the wireless LAN transceiver 45′ and the cellular transceiver 40 (or another type of wireless transceiver) of FIG. 2 may be included in the same device, as will be appreciated by those skilled in the art.

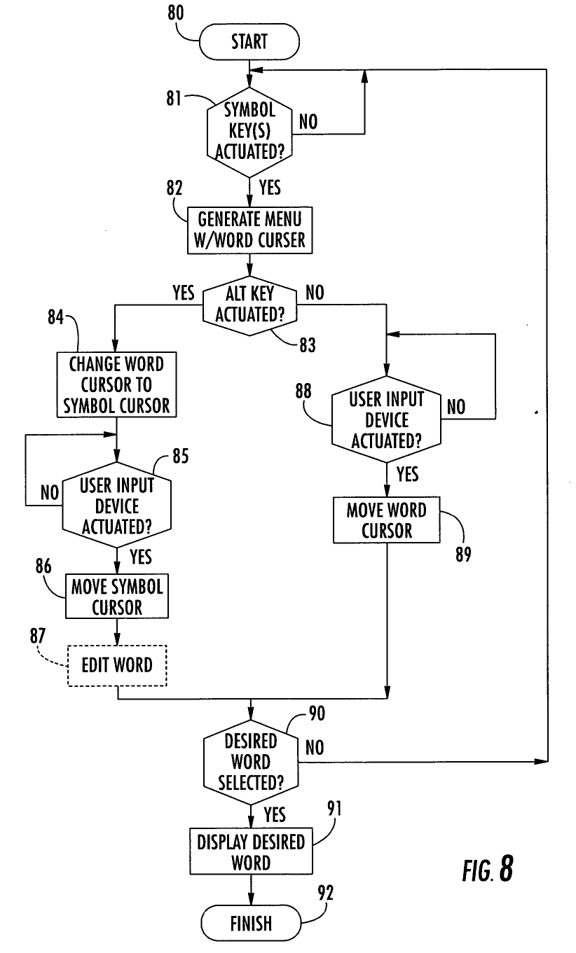

A method aspect of the invention is for using the mobile wireless communications device 20, and is now described with reference to FIG. 8. Beginning at Block 80, the controller 43 generates the menu 50 of possible desired words and the word cursor 51 upon actuation of the multi-symbol keys 24, at Blocks 81 and 82, as discussed above. If the alternate function key 25 is actuated (and, optionally, the scroll wheel 37 is rolled), at Block 83, the controller 43 then changes the word cursor 51 to a symbol cursor 54 based thereon. As the user input device (i.e., scroll wheel 37) is actuated, at Block 85, the controller 43 moves the symbol cursor through the current word, at Block 86. The controller 43 may optionally allow editing of the current word, at Block 87, as further discussed above.

If the alternate function key 25 is not actuated during typing, the controller 43 remains in the word scrolling and moves the word cursor 51 through the words in the menu 50 based upon actuation (i.e., rolling) of the scroll wheel 37, at Blocks 88 and 89. Once the user fishes editing the desired word, or highlights the desired word with the word cursor 51, this word may then be selected (Block 90) by pressing the scroll wheel 37 inward, or by pressing the return key 29 or space key 27. The controller 43 then displays the desired word in the active document (e.g., email, a notepad document, etc.), at Block 91, thus concluding the illustrated method (Block 92). Of course, it will be appreciated that the above-described method would be repeated as the user continues entering further words. Moreover, if a desired word is not selected, the controller 43 will also return to the step illustrated at Block 81 as the user actuates additional keys.

The controller 43 may be implemented with a microprocessor and associated software modules to be executed thereby, as will be appreciated by those skilled in the art. Moreover, the keypad 23 need not include soft keys as illustrated in FIG. 1, but instead may include other types of keys as well, such as touch keys on a display, for example. It should also be noted that various other multi-symbol key configurations may be used other than the exemplary configuration shown, and a QWERTY layout need not be used in all embodiments. Similarly, other arrangements of numbers on the keypad 23 may be used as well.

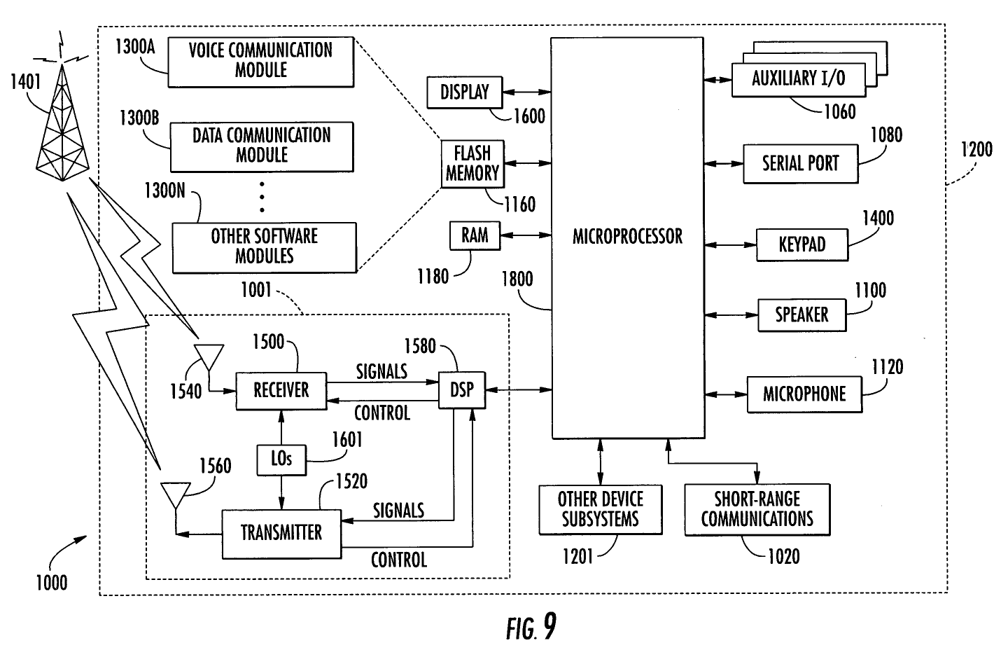

Another example of a handheld mobile wireless communications device 1000 that may be used in accordance the present invention is further described in the example below with reference to FIG. 9. The device 1000 includes a housing 1200, a keypad 1400 and an output device 1600. The output device shown is a display 1600, which is preferably a full graphic LCD. Other types of output devices may alternatively be utilized. A processing device 1800 is contained within the housing 1200 and is coupled between the keypad 1400 and the display 1600. The processing device 1800 controls the operation of the display 1600, as well as the overall operation of the mobile device 1000, in response to actuation of keys on the keypad 1400 by the user.

The housing 1200 may be elongated vertically, or may take on other sizes and shapes (including clamshell housing structures). The keypad may include a mode selection key, or other hardware or software for switching between text entry and telephony entry.

In addition to the processing device 1800, other parts of the mobile device 1000 are shown schematically in FIG. 9. These include a communications subsystem 1001; a short-range communications subsystem 1020; the keypad 1400 and the display 1600, along with other input/output devices 1060, 1080, 1100 and 1120; as well as memory devices 1160, 1180 and various other device subsystems 1201. The mobile device 1000 is preferably a two-way RF communications device having voice and data communications capabilities. In addition, the mobile device 1000 preferably has the capability to communicate with other computer systems via the Internet.

Operating system software executed by the processing device 1800 is preferably stored in a persistent store, such as the flash memory 1160, but may be stored in other types of memory devices, such as a read only memory (ROM) or similar storage element. In addition, system software, specific device applications, or parts thereof, may be temporarily loaded into a volatile store, such as the random access memory (RAM) 1180. Communications signals received by the mobile device may also be stored in the RAM 1180.

The processing device 1800, in addition to its operating system functions, enables execution of software applications 1300A-1300N on the device 1000. A predetermined set of applications that control basic device operations, such as data and voice communications 1300A and 1300B, may be installed on the device 1000 during manufacture. In addition, a personal information manager (PIM) application may be installed during manufacture. The PIM is preferably capable of organizing and managing data items, such as e-mail, calendar events, voice mails, appointments, and task items. The PIM application is also preferably capable of sending and receiving data items via a wireless network 1401. Preferably, the PIM data items are seamlessly integrated, synchronized and updated via the wireless network 1401 with the device user's corresponding data items stored or associated with a host computer system.

Communication functions, including data and voice communications, are performed through the communications subsystem 1001, and possibly through the short-range communications subsystem. The communications subsystem 1001 includes a receiver 1500, a transmitter 1520, and one or more antennas 1540 and 1560. In addition, the communications subsystem 1001 also includes a processing module, such as a digital signal processor (DSP) 1580, and local oscillators (LOs) 1601. The specific design and implementation of the communications subsystem 1001 is dependent upon the communications network in which the mobile device 1000 is intended to operate. For example, a mobile device 1000 may include a communications subsystem 1001 designed to operate with the Mobitex™, Data TAC™ or General Packet Radio Service (GPRS) mobile data communications networks, and also designed to operate with any of a variety of voice communications networks, such as AMPS, TDMA, CDMA, PCS, GSM, etc. Other types of data and voice networks, both separate and integrated, may also be utilized with the mobile device 1000.

Network access requirements vary depending upon the type of communication system. For example, in the Mobitex and DataTAC networks, mobile devices are registered on the network using a unique personal identification number or PIN associated with each device. In GPRS networks, however, network access is associated with a subscriber or user of a device. A GPRS device therefore requires a subscriber identity module, commonly referred to as a SIM card, in order to operate on a GPRS network.

When required network registration or activation procedures have been completed, the mobile device 1000 may send and receive communications signals over the communication network 1401. Signals received from the communications network 1401 by the antenna 1540 are routed to the receiver 1500, which provides for signal amplification, frequency down conversion, filtering, channel selection, etc., and may also provide analog to digital conversion. Analog-to-digital conversion of the received signal allows the DSP 1580 to perform more complex communications functions, such as demodulation and decoding. In a similar manner, signals to be transmitted to the network 1401 are processed (e.g. modulated and encoded) by the DSP 1580 and are then provided to the transmitter 1520 for digital to analog conversion, frequency up conversion, filtering, amplification and transmission to the communication network 1401 (or networks) via the antenna 1560.

In addition to processing communications signals, the DSP 1580 provides for control of the receiver 1500 and the transmitter 1520. For example, gains applied to communications signals in the receiver 1500 and transmitter 1520 may be adaptively controlled through automatic gain control algorithms implemented in the DSP 1580.

In a data communications mode, a received signal, such as a text message or web page download, is processed by the communications subsystem 1001 and is input to the processing device 1800. The received signal is then further processed by the processing device 1800 for an output to the display 1600, or alternatively to some other auxiliary I/O device 1060. A device user may also compose data items, such as e-mail messages, using the keypad 1400 and/or some other auxiliary I/O device 1060, such as a touchpad, a rocker switch, a thumb-wheel, or some other type of input device. The composed data items may then be transmitted over the communications network 1401 via the communications subsystem 1001.

In a voice communications mode, overall operation of the device is substantially similar to the data communications mode, except that received signals are output to a speaker 1100, and signals for transmission are generated by a microphone 1120. Alternative voice or audio I/O subsystems, such as a voice message recording subsystem, may also be implemented on the device 1000. In addition, the display 1600 may also be utilized in voice communications mode, for example to display the identity of a calling party, the duration of a voice call, or other voice call related information.

The short-range communications subsystem enables communication between the mobile device 1000 and other proximate systems or devices, which need not necessarily be similar devices. For example, the short-range communications subsystem may include an infrared device and associated circuits and components, or a Bluetooth communications module to provide for communication with similarly-enabled systems and devices.

Many modifications and other embodiments of the invention will come to the mind of one skilled in the art having the benefit of the teachings presented in the foregoing descriptions and the associated drawings. Therefore, it is understood that the invention is not to be limited to the specific embodiments disclosed, and that modifications and embodiments are intended to be included within the scope of the appended claims.

That which is claimed is:

1. A mobile wireless communications device comprising:
a portable, handheld housing;
a display carried by said portable, handheld housing;
a keypad carried by said portable, handheld housing and comprising a plurality of symbol keys each having indicia of at least one respective symbol thereon, and an alternate function key;
a user input device carried by said portable, handheld housing; and
a controller carried by said portable, handheld housing and connected to said display and said keypad for
generating a menu of possible desired words based upon actuation of said symbol keys,
generating a word cursor in the menu for scrolling through the possible desired words based upon said user input device, and
changing the word cursor to a symbol cursor based upon actuation of said alternate function key for scrolling through symbols in at least one of the possible desired words based upon said user input device.

2. The mobile wireless communications device of claim 1 wherein said controller generates a scrolling mode indicator in the menu for indicating whether word scrolling or symbol scrolling is active.

3. The mobile wireless communications device of claim 2 wherein said controller causes the scrolling mode indicator to change appearance based upon actuation of said alternate function key to indicate that symbol scrolling is active.

4. The mobile wireless communications device of claim 3 wherein the scrolling mode indicator comprises at least one arrow, and wherein said controller causes the at least one arrow to change direction upon actuation of said alternate function key.

5. The mobile wireless communications device of claim 1 wherein the symbol cursor is for scrolling through symbols in a last word selected by the word cursor.

6. The mobile wireless communications device of claim 1 wherein said controller is also for allowing at least one possible desired word to be edited when symbol scrolling is active.

7. The mobile wireless communications device of claim 1 wherein said user input device comprises a scroll wheel.

8. The mobile wireless communications device of claim 1 wherein said controller changes the word cursor to the symbol cursor based upon actuation of said alternate function key and said user input device.

9. The mobile wireless communications device of claim 1 further comprising a wireless transceiver carried by said portable, handheld housing; and wherein said controller cooperates with said wireless transceiver for communicating over a wireless communications network.

10. The mobile wireless communications device of claim 9 wherein said wireless transceiver comprises a cellular transceiver.

11. The mobile wireless communications device of claim 9 wherein said wireless transceiver comprises a wireless local area network (WLAN) transceiver.

12. The mobile wireless communications device of claim 1 wherein a set of said symbol keys have indicia of a plurality of respective symbols thereon to define multi-symbol keys.

13. The mobile wireless communications device of claim 1 wherein the symbols comprise letters; and wherein said symbol keys are arranged to define a QWERTY layout.

14. A mobile wireless communications device comprising:
a portable, handheld housing;
a display carried by said portable, handheld housing;
a keypad carried by said portable, handheld housing and comprising a plurality of symbol keys each having indicia of at least one respective symbol thereon, and an alternate function key;
a user input device carried by said portable, handheld housing;
a wireless transceiver carried by said portable, handheld housing; and
a controller carried by said portable, handheld housing and connected to said display and said keypad for
generating a menu of possible desired words based upon actuation of said symbol keys,
generating a word cursor in the menu for scrolling through the possible desired words based upon said user input device,
changing the word cursor to a symbol cursor based upon actuation of said alternate function key for scrolling through symbols in at least one of the possible desired words based upon said user input device,
generating a scrolling mode indicator in the menu for indicating whether word scrolling or symbol scrolling is active, and
cooperating with said wireless transceiver to communicate over a wireless network.

15. The mobile wireless communications device of claim 14 wherein said controller causes the scrolling mode indicator to change appearance based upon actuation of said alternate function key to indicate that symbol scrolling is active.

16. The mobile wireless communications device of claim 15 wherein the scrolling mode indicator comprises at least one arrow, and wherein said controller causes the at least one arrow to change direction upon actuation of said alternate function key.

17. The mobile wireless communications device of claim 14 wherein the symbol cursor is for scrolling through symbols in a last word selected by the word cursor.

18. The mobile wireless communications device of claim 14 wherein said controller is also for allowing at least one possible desired word to be edited when symbol scrolling is active.

19. The mobile wireless communications device of claim 14 wherein said user input device comprises a scroll wheel.

20. The mobile wireless communications device of claim 14 wherein said controller changes the word cursor to the symbol cursor based upon actuation of said alternate function key and said user input device.

21. The mobile wireless communications device of claim 14 wherein said wireless transceiver comprises a cellular transceiver.

22. The mobile wireless communications device of claim 14 wherein said wireless transceiver comprises a wireless local area network (WLAN) transceiver.

23. The mobile wireless communications device of claim 14 wherein a set of said symbol keys have indicia of a plurality of respective symbols thereon to define multi-symbol keys.

24. The mobile wireless communications device of claim 14 wherein the symbols comprise letters; and wherein said symbol keys are arranged to define a QWERTY layout.

25. A method for using a mobile wireless communications device comprising a portable, handheld housing, a display carried by the portable, handheld housing, a keypad carried by the portable, handheld housing and comprising a plurality of symbol keys each having indicia of at least one respective symbol thereon, and an alternate function key, and a user input device carried by the portable, handheld housing, the method comprising:
generating a menu of possible desired words based upon actuation of the symbol keys,
generating a word cursor in the menu for scrolling through the possible desired words based upon the user input device; and
changing the word cursor to a symbol cursor based upon actuation of the alternate function key for scrolling through symbols in at least one of the possible desired words based upon the user input device.

26. The method of claim 25 further comprising generating a scrolling mode indicator in the menu for indicating whether word scrolling or symbol scrolling is active.

27. The method of claim 26 wherein further comprising causing the scrolling mode indicator to change appearance based upon actuation of the alternate function key to indicate that symbol scrolling is active.

28. The method of claim 27 wherein the scrolling mode indicator comprises at least one arrow, and wherein causing the scrolling mode indicator to change appearance comprises causing the at least one arrow to change direction upon actuation of the alternate function key.

29. The method of claim 25 wherein the symbol cursor is for scrolling through symbols in a last word selected by the word cursor.

30. The method of claim 25 further comprising allowing at least one possible desired word to be edited when symbol scrolling is active.

31. The method of claim 25 wherein the mobile wireless communications device further comprises a wireless transceiver carried by the portable, handheld housing; and further comprising using the wireless transceiver for communicating over a wireless network.

32. The method of claim 25 wherein changing comprises changing the word cursor to a symbol cursor based upon actuation of the alternate function key and the user input device.
